(19) United States
(12) Patent Application Publication
(10) Pub. No.: US 2026/0225639 A1
(43) Pub. Date: Aug. 6, 2026

(54) POWER-ASSISTED STROLLER WITH ROCKING FEATURE

(71) Applicant: Graco Children’s Products Inc., Atlanta, GA (US)

(72) Inventors: Devin Rajan, Atlanta, GA (US); Darren Zhen Kit Tan, Marietta, GA (US); Ryan David Luecke, Marietta, GA (US); Joonho Na, Alpharetta, GA (US)

(73) Assignee: Graco Children’s Products Inc., Atlanta, GA (US)

(21) Appl. No.: 19/457,444

(22) Filed: Jan. 23, 2026

Related U.S. Application Data
(60) Provisional application No. 63/753,642, filed on Feb. 4, 2025.

(51) Int. Cl. B62B 9/22; B62B 9/08

(52) U.S. Cl. CPC B62B 9/22; B62B 9/085

(57) ABSTRACT

A power-assisted stroller with a rocking feature is provided. The stroller includes two motors each coupled to a respective back wheel of the stroller. Each of the back wheels also includes a pedal assembly that is positioned off-axis from the motor and the back wheels. The pedal assembly includes a brake mechanism and a rocking mechanism. When the pedal assembly is rotated, a rocking pin of the rocking mechanism engages with a slot in a rocking lifter of the pedal assembly and with an elongated slot in the motor cover. The rocking mechanism includes a spring that is configured to bias the rocking pin and the rocking pin housing such that the rocking pin engages with the slot in the rocking lifter at the same position in all operating modes. The two motors are then operated to move the stroller back and forth a predetermined number of degrees.

### CROSS-REFERENCE TO RELATED APPLICATION

This application claims the benefit of US application no. 63/753,642, filed February 4, 2025, the entirety of which is hereby incorporated by reference.

### TECHNICAL FIELD

The present disclosure relates generally to strollers. Specifically, the embodiments of the present disclosure are related to a power-assisted stroller that has an integrated rocking feature.

### BACKGROUND

Some strollers offer a rocking feature. The rocking feature allows the stroller to move back and forth in a gentle, rocking motion, similar to a cradle or rocking chair. This feature is intended to help soothe and comfort a baby/infant by mimicking the natural, rhythmic movements that can be calming and sleep-inducing.

However, the rocking mechanism offered in conventional strollers may have a limited range of motion, making the rocking feature ineffective in soothing a baby. In addition, the rocking motion may not be smooth or consistent due to design or weight distribution issues. Further, the conventional rocking mechanism may not work well on uneven or soft surfaces like grass or carpets. There is a need in the industry for a product that can generate an effective, jerk-free, and consistent rocking motion that has a sufficient range of motion on most of the surfaces.

### BRIEF DESCRIPTION OF THE DRAWINGS

FIGS. 1A and 1B illustrate views of a rear wheel subassembly of a stroller in accordance with the principles of the present disclosure.

FIGS. 2A-2D illustrate details of a pedal assembly of a stroller in accordance with the principles of the present disclosure.

FIGS. 3A-3C illustrate details of the rocking lifter in accordance with the principles of the present disclosure.

FIGS. 4A-4C illustrate a portion of the rocking mechanism assembly in accordance with the principles of the present disclosure.

FIGS. 5A-5C illustrate details of portions of the pedal assembly, the motor, and the wheel in accordance with the principles of the present disclosure.

FIGS. 6A-6D illustrate schematics that explain the operation of the rocking feature of a stroller in accordance with the principles of the present disclosure.

FIG. 7 illustrates a block diagram of a system of a power-assisted stroller in accordance with the principles of the present disclosure.

FIG. 8 is a flow diagram of a process for executing the rocking feature in accordance with the principles of the present disclosure.

FIG. 9 illustrates a stroller in accordance with the principles of the present disclosure.

The drawings are provided for purposes of illustration only and merely depict example embodiments of the disclosure. The drawings are provided to facilitate understanding of the disclosure and shall not be deemed to limit the breadth, scope, or applicability of the disclosure. The use of the same reference numerals indicates similar, but not necessarily the same or identical components. Different reference numerals may be used to identify similar components. Various embodiments may utilize elements or components other than those illustrated in the drawings, and some elements and/or components may not be present in various embodiments. The use of singular terminology to describe a component or element may, depending on the context, encompass a plural number of such components or elements and vice versa.

### DETAILED DESCRIPTION

The various embodiments of the rocking mechanism described herein advantageously provide a consistent, safe, and robust rocking feature. The embodiments are described in detail herein to enable one of ordinary skill in the art to practice the improved stroller including the rocking feature, although it is to be understood that other embodiments may be utilized and that logical changes may be made without departing from the scope of the disclosure. Reference is made herein to the accompanying drawings illustrating some embodiments of the disclosure, in which use of the same reference numerals indicates similar or identical items. Throughout the disclosure, depending on the context, singular and plural terminology may be used interchangeably.

The meanings of the terms used herein will be apparent to one of ordinary skill in the art or will become apparent to one of ordinary skill in the art upon review of the detailed description when taken in conjunction with the several drawings and the appended claims.

Embodiments of the present disclosure provide a stroller that includes a first wheel and a second wheel. The stroller further includes a first motor assembly coupled to the first wheel and a second motor assembly coupled to the second wheel. The stroller further includes a first pedal assembly coupled to the first motor assembly. The first pedal assembly further includes a first pin and a second pin, a rocking lifter defining a slot therein, a pin housing at least partially encompassing the second pin, a first pin configured to engage with a first opening of the motor assembly, a second pin configured to engage with a second opening of the motor assembly and the slot, and a first spring coupled to the pin housing and the rocking lifter.

Other embodiments of the present disclosure provide a stroller that includes a wheel and a motor assembly comprising a motor coupled to the wheel. The stroller further includes a pedal assembly that is coupled to the motor and the wheel, and the pedal assembly is rotatable around a first axis while the motor is rotatable around a second axis that is different from the first axis. The pedal assembly further includes a pedal lever, a first pin partially disposed in a first housing, a second pin partially disposed in a second housing, a spring coupled to the second housing and located adjacent to the second housing; and a rocking lifter coupled to the second housing.

Some other embodiment of the present disclosure includes a method for effecting a rocking motion for a stroller. The method includes control logic of a stroller operating a motor of the stroller in a first direction by a pre-defined number of degrees. The method further includes the control logic determining that the motor cannot be rotated in the first direction beyond the pre-defined number of degrees. Thereafter, the method includes the control logic operating the motor in a second direction by the pre-defined number of degrees, the second direction being opposite the first direction. Thereafter the method further includes the control logic operating the motor in the first direction by a first number of degrees and in the second direction by the first number of degrees. The first number of degrees is less than the pre-defined number of degrees.

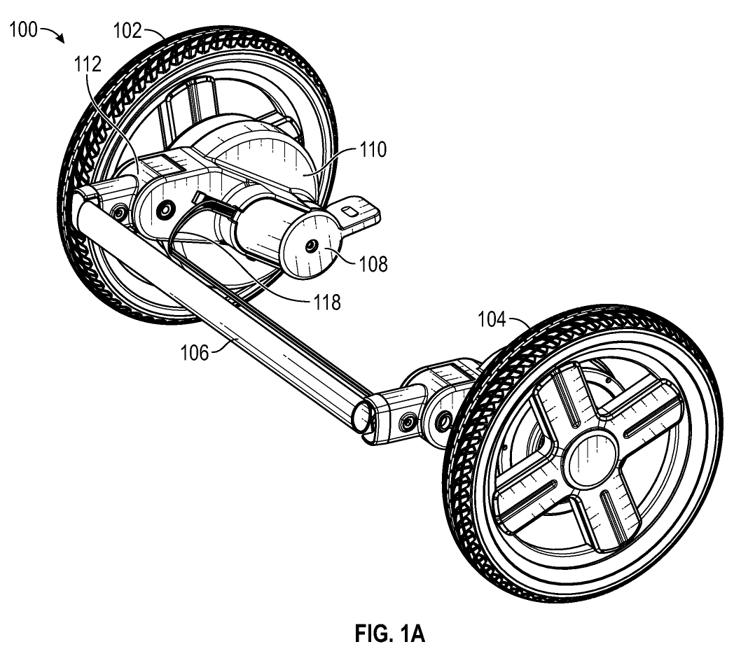

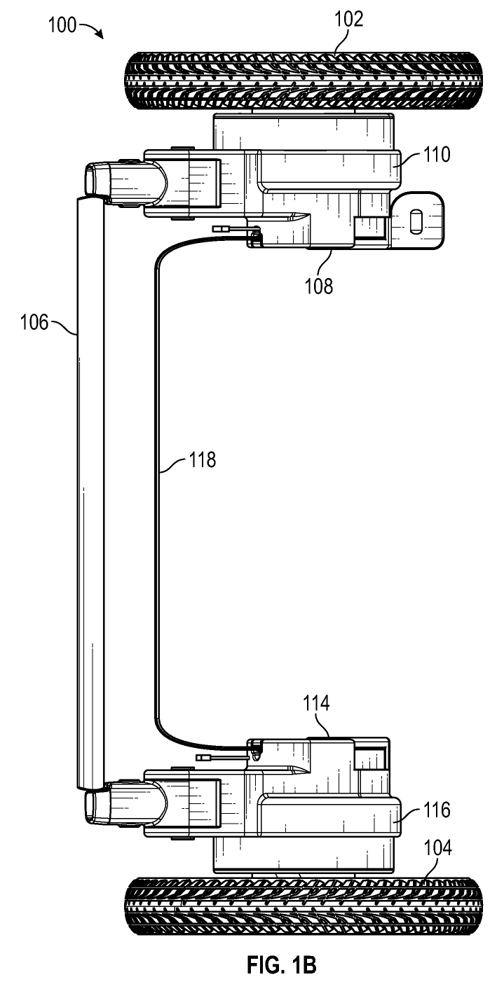

FIGS. 1A and 1B illustrate views of a rear wheel subassembly 100 of a stroller in accordance with the principles of the present disclosure. The rear wheel subassembly 100 may include two wheels, a first wheel 102 and a second wheel 104. The first wheel 102 and the second wheel 104 are coupled together by a link member 106. The link member 106 provides mechanical rigidity to the stroller and also ensures the first wheel 102 and the second wheel 104 operate freely and/or independently when the stroller is operated. A separate hinge assembly 112 is coupled to each end of the link member 106. A first hinge assembly 112 is coupled to the first wheel 102 and a second hinge assembly 112 is coupled to the second wheel 104. The hinge assembly 112 coupled to each of the first wheel 102 and the second wheel 104 is identical in its construction.

The first wheel 102 includes first a motor assembly 110 that is coupled to the first wheel 102. The first motor assembly 110 includes a motor and other components that cause the wheel to rotate in clockwise and/or anticlockwise direction based on the operating mode of the stroller. The motor can include a brushless DC motor, a stepper motor, or the like. The second wheel 104 also includes a second motor assembly 116 coupled to the second wheel 104. A first pedal assembly 108 is coupled to the first wheel 102 via the first motor assembly 110. A second pedal assembly 114 is coupled to the second wheel 104 via the second motor assembly 116. The first pedal assembly 108 and the second pedal assembly 114 are not identical in their construction and include a few differences as explained below. The first pedal assembly 108 and the second pedal assembly 114 are coupled together by a cable 118. The first pedal assembly 108 can be operated by the user to engage a brake of the stroller or enable a rocking mode of the stroller. The mechanical operation of the first pedal assembly 108 is translated by the cable 118 to the second pedal assembly 114. Thus, when the first pedal assembly 108 is operated to engage a brake of the stroller, the second pedal assembly 114 also operates to engage a brake of the stroller. When the first pedal assembly 108 is operated to engage a rocking mode of the stroller, the second pedal assembly 114 also operates to engage the rocking mode. Thus, the first pedal assembly 108 and the second pedal assembly 114 operate in unison by manipulation of only the first pedal assembly 108.

Each of the first motor assembly 110 and the second motor assembly 116 are electrically coupled to a control unit of the stroller. Operation of the control unit causes electrical signals and data to be sent to each of the first motor assembly 110 and the second motor assembly 116. The first motor assembly 110 and the second motor assembly 116 each may include a motor and associated control logic to operate the motors.

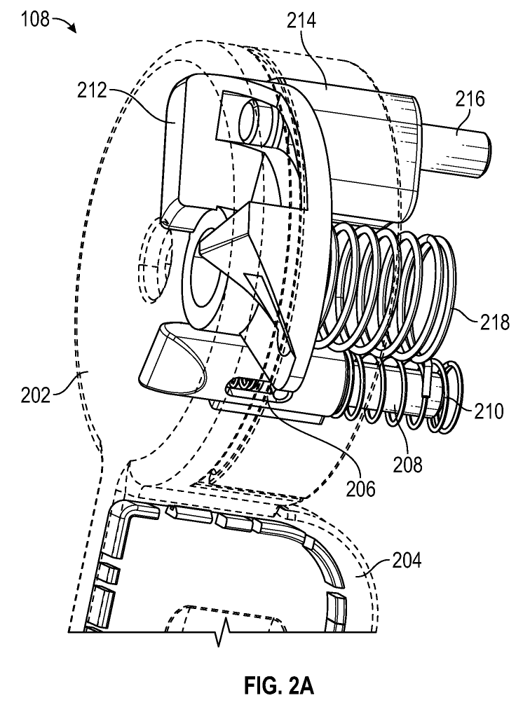

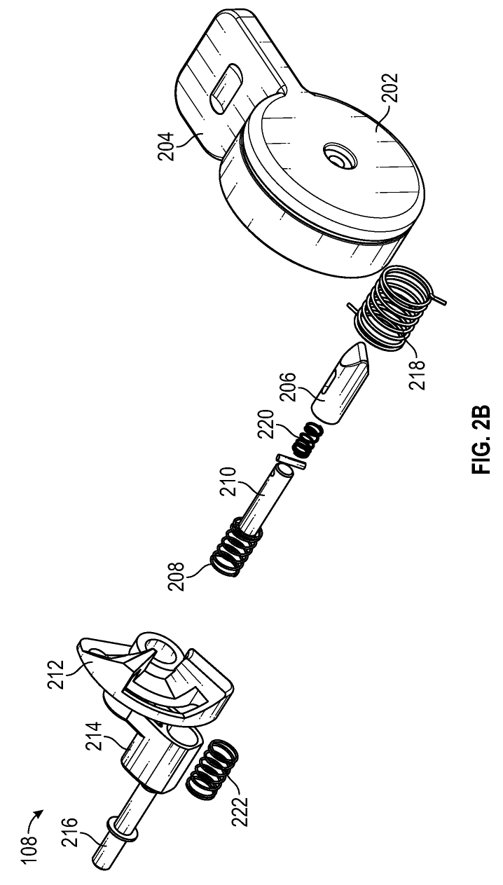

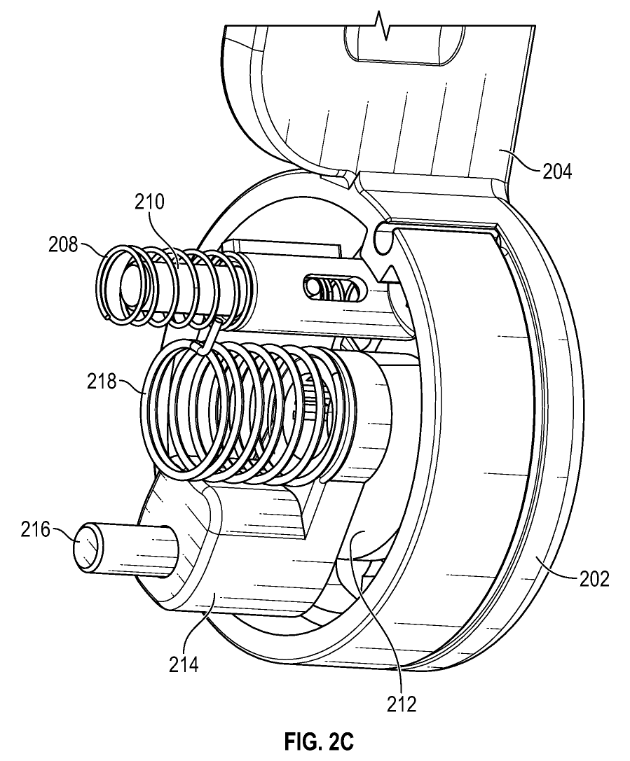

FIGS. 2A-2C illustrate details of the first pedal assembly 108 in accordance with the principles of the present disclosure. FIG. 2A illustrates the various components that are part of the first pedal assembly 108 and their location with respect to each other. FIG. 2B illustrates an exploded view of the various components of the pedal assembly 108. As illustrated, the first pedal assembly 108 includes a pedal cover 202 and a lever 204 attached to the pedal cover 202. In some embodiments, the pedal cover 202 and the lever 204 may be a single unit made of plastic or metal. The lever 204 may be manually moved in a radial direction to engage the brake of the stroller and/or engage the rocking feature of the stroller. In an embodiment, a user may operate the lever 204 with his/her foot to press the lever 204 toward the ground and/or press the lever 204 upward away from the ground. In a specific embodiment, pressing the lever 204 toward the ground engages the brake of the stroller and disengages the rocking feature and lifting the lever 204 upward and away from the ground and engages the rocking feature of the stroller and disengages the brake of the stroller. One skilled in the art will realize that other types of motion for the lever 204 can also be designed to engage/disengage the brake and/or the rocking feature.

The first pedal assembly 108 further includes a brake pin housing 206, a brake pin 210, a brake spring 208, and a biasing spring 220. In an embodiment, the brake spring 208 is a compression spring that applies a pressure on the brake pin 210 to keep the brake pin disengaged from a corresponding brake mechanism on the wheel 102 when the stroller is being operated in its default state. In an embodiment, when the lever 204 is placed in a first position (e.g., pressed down toward the ground), a feature inside the pedal cover 202 causes the brake pin housing 206 to translate toward the wheel, compressing the brake spring 208, and the brake pin 210 engages with one of several openings in the motor cover (described below) to engage the brake of the stroller and cause the stroller to be held in place. A similar brake mechanism is also included in the second pedal assembly 114 and operates similarly to engage the brake on the second wheel 104. Once the brake is engaged, the brake spring 208 and the biasing spring 220 ensure that the brake pin 210 stays engaged in the opening of the motor cover to hold the stroller in place. In an embodiment, the brake spring 208 encircles the brake pin 210 and sits atop the brake pin housing 206, as illustrated in FIG. 2C. When the brake of the stroller is disengaged, the brake pin 210 is disposed at least partially within the brake pin housing 206 and partially within the brake spring 208.

The first pedal assembly 108 further includes a rocking lifter 212, a rocking pin 216, a rocking pin housing 214, a rocking spring 218, and a second biasing spring 222. The rocking lifter 212 includes a slot. In an embodiment, the slot is semicircular in shape although other shapes for the slot are also within the scope of this disclosure. The rocking pin housing 214 is coupled to the rocking pin lifter 214. The rocking pin 216 is disposed within the rocking pin housing 214. The rocking pin 216 is configured to traverse in a lateral direction toward the first wheel 102 when the rocking mode is enabled. The other end of the rocking pin 216 is disposed within the slot present in the rocking pin lifter 214. The rocking spring 218 is coupled to both the rocking lifter 212 and the rocking pin housing 214 at a common point on the rocking pin lifter 212. The rocking spring 218 is placed adjacent to the rocking pin housing 214 such that it provides a biasing force in a specific direction to ensure that the rocking pin 216 is always positioned at the same location within the slot of the rocking pin lifter 214 once the rocking mode is enabled. The operation of the rocking pin lifter 214, the rocking pin 216, and the rocking spring 218 are described below in detail.

FIG. 2D illustrates a view of the pedal assembly cover in accordance with the principles of the present disclosure. The pedal cover 202 includes a recessed region 224 within which the components of the first pedal assembly 108 are at least partially disposed. A raised structure 226 is disposed in the recessed region 224. The raised structure 226 includes one or more recessed regions 228 and 230. The raised structure 226 has a varying height along the length of the raised structure 226. For instance, the raised structure 226 has a first height at one end and a second height at the other end. In an embodiment, the first height is greater than the second height. In an embodiment, the raised structure 226 may have gradual decrease in height from one of its ends to the other end. The recessed regions 228 and 230 are configured to engage with the brake pin housing 206. For instance, when the brake is engaged, the brake pin housing 206 may engage with the recessed region 228 and sit partially within the recessed region 228. When the brake is disengaged, the brake pin housing 206 may engage with the recessed region 230 and sit partially within the recessed region 230. Since the height of the raised structure 226 is greater at the recessed region 228 than at the recessed region 230, it may result in the brake pin housing 206 being pushed toward the first wheel 102. The first biasing spring 220 pushes the brake pin 210 toward the first wheel 102, and as a result, the brake pin passes through an opening in a motor cover preventing any further movement of the first wheel 102 and thus effectively causing the stroller to remain in a stopped state. As long as the brake pin is engaged with the motor cover, the stroller cannot move forward or backward. When the brake is disengaged (e.g., by moving the lever 204), the pedal cover 202 rotates to cause the brake pin housing 206 to disengage from the recessed region 228 and engage with the recessed region 230. Since the height of the raised structure 226 is lower at the recessed region 230 than at the recessed region 228, it results in the brake pin housing 206 sliding back toward the pedal cover 202 and the brake pin 210 retracting from the opening in the motor cover. Now the stroller can be moved forward or backward.

The pedal cover 202 includes two more raised structures 232 and 234 that are placed opposite to the raised structure 226. Both the raised structures 232 and 234 are shorter in length than the raised structure 226. In an embodiment, the raised structure 232 is placed parallel to the other raised structure 234. In another embodiment, one of the raised structures 234 is larger than the other raised structure 232. At least one surface of each of the raised structures 232 and 234 has a sloped profile and a top surface of each of the raised structures 232 and 234 is flat or planar. The raised structures 232 and/or 234 are configured to come in contact with a portion of the rocking lifter 212 when the rocking mode is enabled. For instance, when the lever 204 is operated to rotate the pedal cover 202, one and/or both of the raised structures 232 and 234 come in contact with a corresponding raised portion of the rocking lifter 212.

In some embodiments, an external detent feature may be included within the brake/rocking pedal. Historically, stroller brake pedals lock into place using a groove that is cut at the top of a ramp so that the spring loaded brake pin can locate itself within the groove when the pedal is moved to the approximately correct position. The downside of this is that the strength of the detent feature can be hard to isolate and control apart from the other features within the pedal. To address this, embodiments can include a spring-loaded part that travels on a separate grooved track to control the strength of the detent-ed positions. By controlling the spring force acting on the external detent, the detent may be isolated without altering the geometry or spring force acting on the brake and rocking pins. The external detent part therefore can rotate with the pedal and ride on the grooved track within the rear wheel housing.

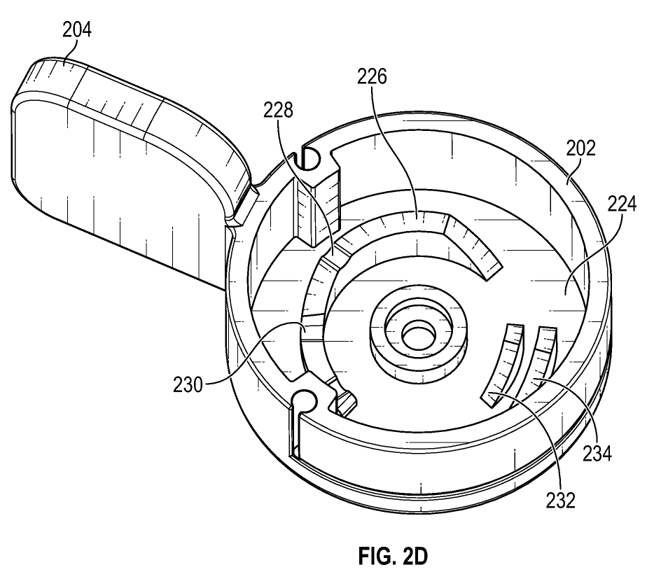

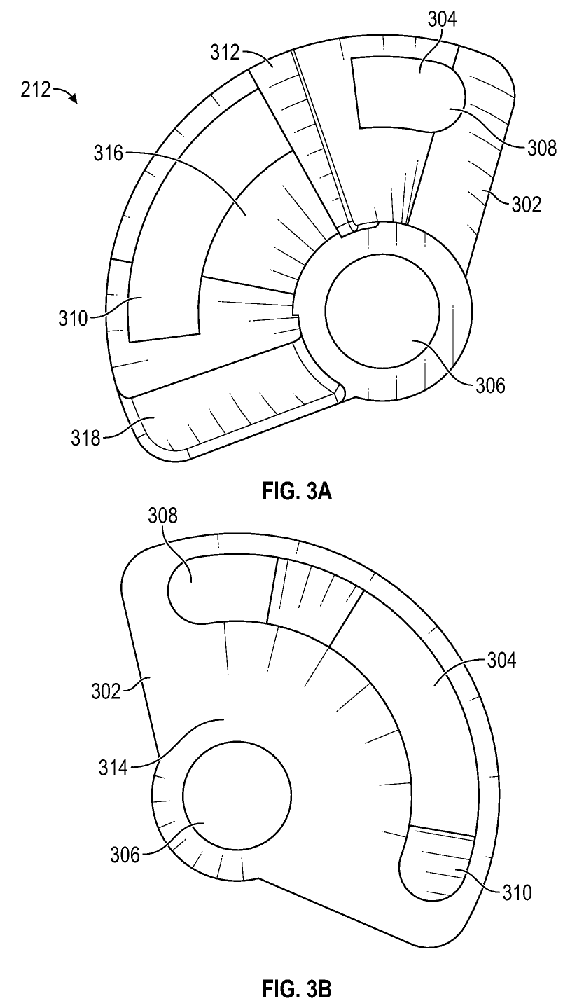

FIGS. 3A-3C illustrate details of the rocking lifter 212 in accordance with the principles of the present disclosure. The rocking lifter 212 includes a body 302 that has a planar surface 314 and opposing non-planar surface 316. A slot 304 is defined within an upper portion of the body 302. The slot extends from a first end 308 to a second end 310. The two ends of the slot 304 act as the emergency hard stops for the rocking pin 216 and define the maximum extent for the travel of the rocking pin 216. The slot 304 ensures that the force of the rocking pin 216 is not translated entirely into the rocking pin housing 214. The rocking lifter 212 also includes another opening 306. The rocking housing 214 and the rocking spring 218 are configured to be coupled to the rocking lifter 212 at the opening 306. The non-planar surface 316 has a first raised portion 312 and a second raised portion 318. The second raised portion 318 is located toward one end of the body 302 and the first raised portion 312 is located toward an opposing end of the body 302. In an embodiment, the firs raised portion partially overlaps a portion of the slot 304 that is closer to the first end 308. When the rocking mode of the stroller is engaged, the rocking pin 216 is at least partially located within the slot 304 and moves between the first end 308 and the second end 310. The rocking lifter 212 stays stationary in the rocking mode. In an embodiment, the rocking lifter 212 can be made using any suitable material including plastic or metal.

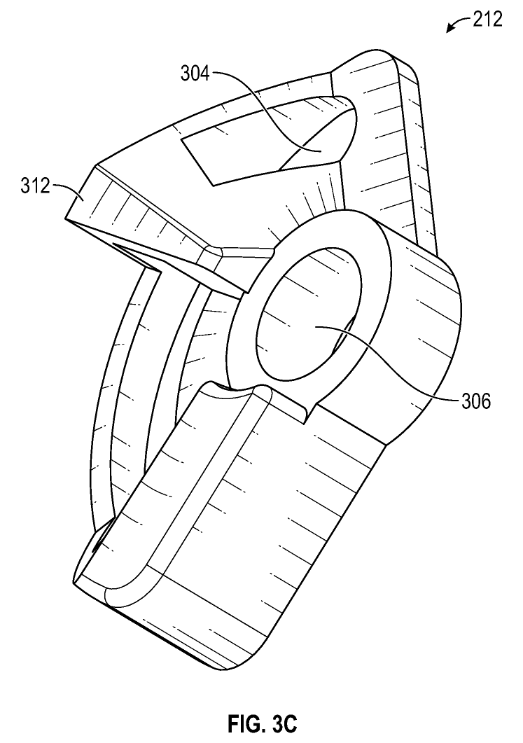

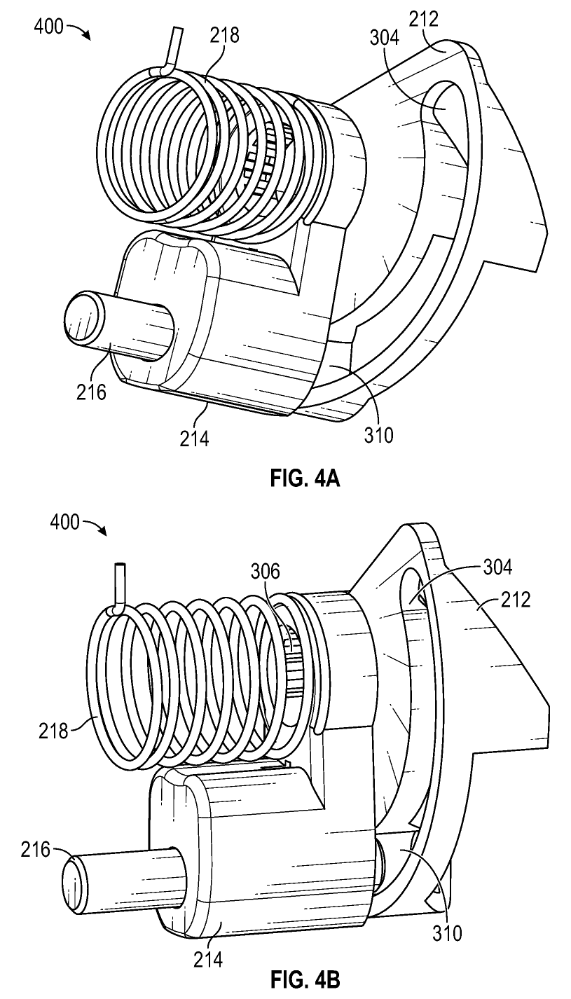

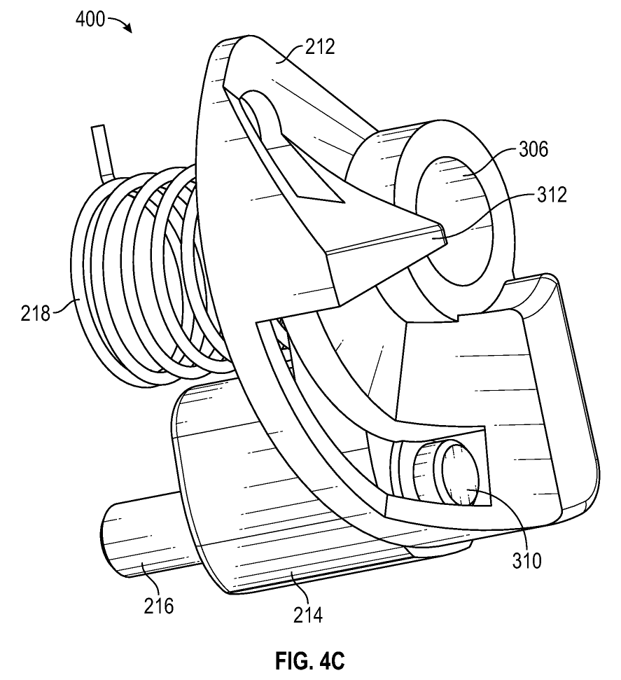

FIGS. 4A-4C illustrate a portion of the rocking mechanism assembly 400 in accordance with the principles of the present disclosure. As illustrated, the rocking spring 218 is coupled to the rocking lifter 212 at the opening 306 of the rocking lifter 212. The rocking pin housing 214 is also coupled to the rocking lifter 212 at the opening 306 of the rocking lifter 212. The rocking pin 216 is partially disposed outside of the rocking pin housing 214 at both ends and partially disposed within the rocking pin housing 214. The second biasing spring 222 is located within the rocking pin housing 214. The rocking spring 218 is located adjacent to the rocking pin housing 214 such that when the rocking mode is enabled, the rocking spring 218 forces the rocking pin housing 214 to place itself in a position such that the rocking pin 216 is placed in the first end 310 of the slot 304 of the rocking lifter 212.

As noted above, the second pedal assembly 114 has an almost identical structure as the first pedal assembly 108. Thus, the second pedal assembly 114 also includes a rocking pin, a rocking pin housing, a rocking spring, a rocking lifter, and a second biasing spring similar to the first pedal assembly 108. When the stroller is in the operation mode where it is either being pushed by a user or is being moved using the motors, both the first wheel 102 and the second wheel 104 will rotate to facilitate the movement of the stroller. When the stroller comes to a stop or is otherwise idle, the first wheel 102 and the second wheel 104 may have rotated differently such that the rocking pin 216 of the first pedal assembly 108 may not be in the same location with respect to the slot 304 of the rocking lifter 212 compared to the rocking pin and the rocking lifter of the second pedal assembly 114. It is beneficial that the rocking pins of both the pedal assemblies 108 and 114 are positioned at the same location with respect to the respective rocking lifters of each of the pedal assemblies 108 and 114. In an embodiment, even when the rocking mode is not enabled, the rocking spring 218 continually pushes on the rocking pin housing 214 such that the rocking pin 216 is biased towards and engages with the end 310 of the slot 304. When the lever 204 is operated to enable the rocking mode of the stroller, the rocking spring 218 of the first pedal assembly 108 further pushes the rocking pin 216 and rocking pin housing 214 such that the rocking pin 216 further engages with the slot 304 at the end 310 of the slot 304. An exact similar operation occurs at the second pedal assembly 114. This ensures that when the rocking mode is enabled, both the rocking pins are positioned in the respective slots of the rocking lifters at the exact same position. Thereafter, when the rocking motion is enabled, both the rocking pins have a similar distance that they can travel within the respective slots 304 ensuring accurate and predictable operation of the rocking feature each time the feature is enabled.

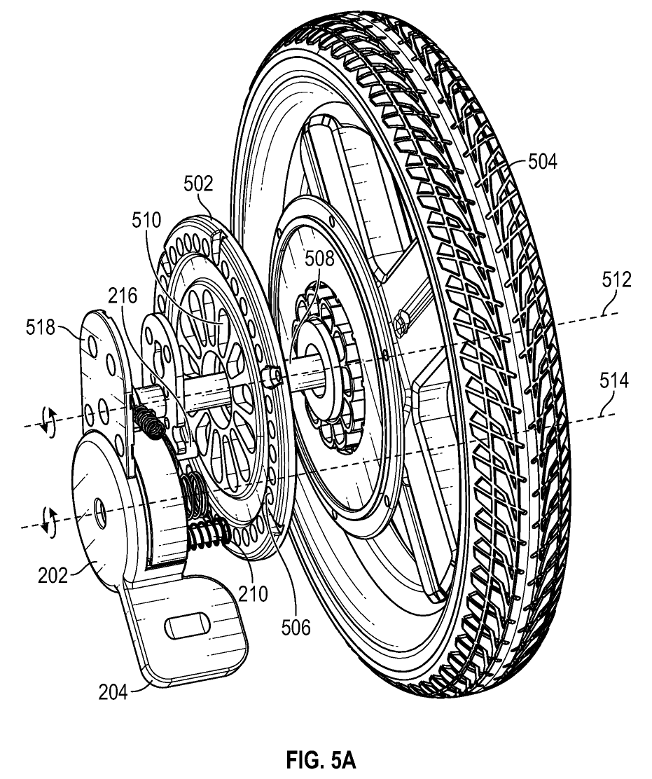

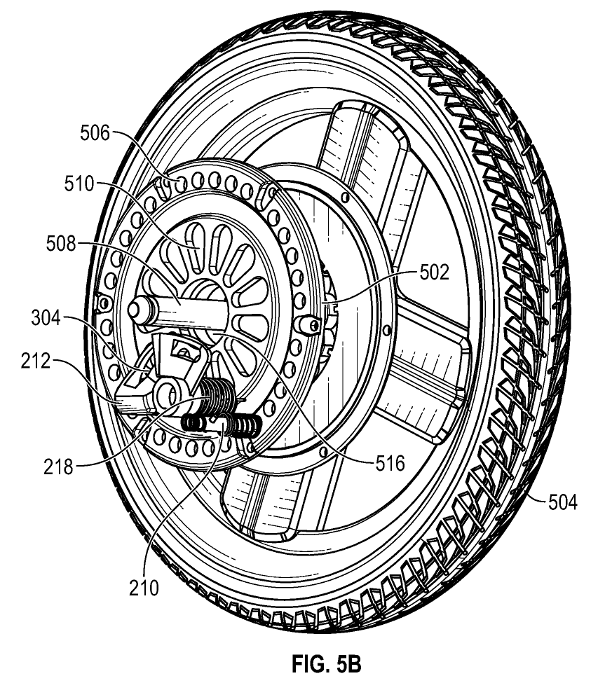

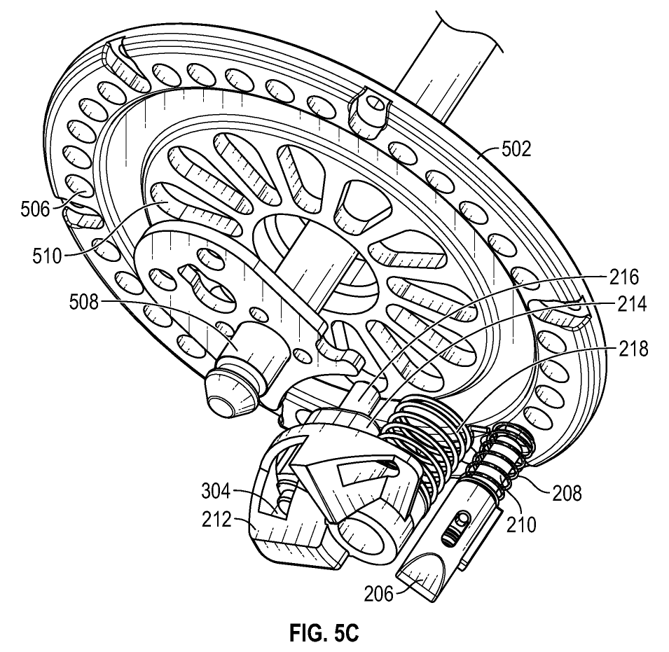

FIGS. 5A-5C illustrate details of portions of the pedal assembly, the motor, and the wheel in accordance with the principles of the present disclosure. The motor assembly of the stroller includes a motor cover 502. The motor cover 502 included a first plurality of openings 506 positioned around the periphery of the motor cover 502. The number of the first plurality of openings 506 depends on the radius/diameter of the motor cover 502. In an embodiment, the first plurality of openings 506 may be circular. The motor cover 502 also includes a second plurality of elongated openings 510 arranged in a circular pattern toward a center of the motor cover 502. The second plurality of openings 510 may be elongated in shape. The second plurality of elongated openings 510 are arranged concentrically to the first plurality of openings 506. The motor cover 502 also includes another opening 516 at its center. An axle 508 passes through the opening 516 and connects the wheel 504 to the motor and to the pedal cover 202. The pedal cover 202 is connected to the axle 508 via a connecting plate 518. As illustrated in FIG. 5A, the pedal cover 202 and the motor cover 502 are not located along the same axis. In other words, the pedal cover 202 and the motor cover 502 are off-axis from each other. For instance, the pedal cover 202 is configured to rotate around a first axis 514, and the motor cover 502 and, by extension the wheel is configured to rotate around a second axis 512. The first axis 514 is parallel to the second axis 512 and separated by a distance from the second axis 512. With reference to the ground plane, the first axis 514 is closer to the ground plane than the second axis 512. In other embodiments, the first plurality of openings 506 may be disposed on the wheel, the rim of the wheel, or other rotating surfaces.

During a default operation of the stroller when the stroller is being pushed around or otherwise in motion, both the rocking pin 216 and the brake pin 210 are in a retracted position and not engaged with any openings on the motor cover 502. In other words, when the stroller is being pushed or otherwise motile, the brake pin 210 is not engaged with any of the first plurality of openings 506 and the rocking pin 216 is not engaged with any of the second plurality of elongated openings 510. This allows the motor cover 502 to rotate freely around the second axis 512 allowing forward and backward motion of the wheel 504. When the user wants to apply the brake for the stroller, the user may press down on the lever 204. This causes the pedal cover 202 to rotate around the first axis 514 in a first direction. The pedal cover then pushes the brake pin housing toward the wheel 504 and biasing spring 220 pushes the brake pin 210 toward the wheel. The brake pin 210 then engages with one of the first plurality of openings 506 of the motor cover 502. This prevents the motor cover 502 and wheel 504 from rotating around the second axis 512 and results in the stroller being unable to move.

If the user wants to enable the rocking mode for the stroller, the user may push upward on the lever 204. This results in the pedal cover rotating around the first axis 514 in a second direction that is opposite to the first direction. This causes the brake pin 210 to retract and disengage from the opening 506. Concurrently, the rotation of the pedal cover 202 in the second direction causes the rocking pin 216 to engage with one of the second plurality of elongated openings 510 and also with the slot 304 of the rocking lifter 212. As explained above, the rocking spring 218 ensures that the brake pin 210 is positioned at the same location within the slot 304 for both the wheels. This ensures that both the wheels 102 and 104 are synchronized in their movement for the rocking motion. In an embodiment, the rocking pin 216 is biased toward the end 310 of the rocking lifter 212. This allows the rocking pin 216 to traverse the full length of the slot 304 allowing the maximum amount of rocking motion for the stroller. However, it is not necessary that the rocking pin 216 has to traverse the entire length of the slot 304 to perform the rocking motion. Once the rocking pin 216 is engaged with one of the second plurality of openings, the stroller is now in the rocking mode and ready to execute the rocking motion. In an alternate embodiment, the motor cover 502 may only have a single set of openings (e.g., openings 506). Further in this embodiment, the pedal and the wheel of the stroller are disposed and rotatable along the same axis. When the rocking feature is enabled for this embodiment, the brake pin 210 retracts from one of the openings in the plurality of the openings 506 while the rocking pin 216 engages with one of the other openings in the same plurality of the openings 506 and the slot 304 in the rocking lifter 212. The rocking pin 216 may then traverse the length of the slot 304, similar to the embodiments described above. In this embodiment, the wheel also moves in sync with the rocking pin by the distance same as the rocking pin.

In another embodiment, the rocking spring 218 may be coupled to the motor cover 502 and may be located between the motor cover 502 and the wheel. In this embodiment, when the rocking mode is enabled, rocking pin 216 may engage with one of the openings 506 and the opening 506 and/or openings 510. The motor cover 502 will stay stationary and the wheels 102 and 104 will rotate. The motor cover 502 may remain locked to the rocking mechanism until the rocking pin 216 is retracted from the opening 506. Once the rocking pin 216 is retracted, the motor cover 510 may snap back in place. In this embodiment, the openings 510 need not be elongated and can be the same as openings 506. The rocking pin 216 remains stationary as part of the rocking motion, however in this instance, rocking spring 218 can cause the motor cover 510 to snap back to its starting point upon completion of one cycle of the rocking motion, similar to the old rotary phone dial. This will ensure that the rocking pin 216 is at the same position in the opening 506 at the start of every rocking motion and the orientation of the opening 506 is always synced between the left and right wheels. In this embodiment, the rocking pin 216 does not move during the rocking motion. The range of rocking motion in the rocking mode is dependent on how much each motor cover 502 can rotate in relation to the respective wheels 102 and 104.

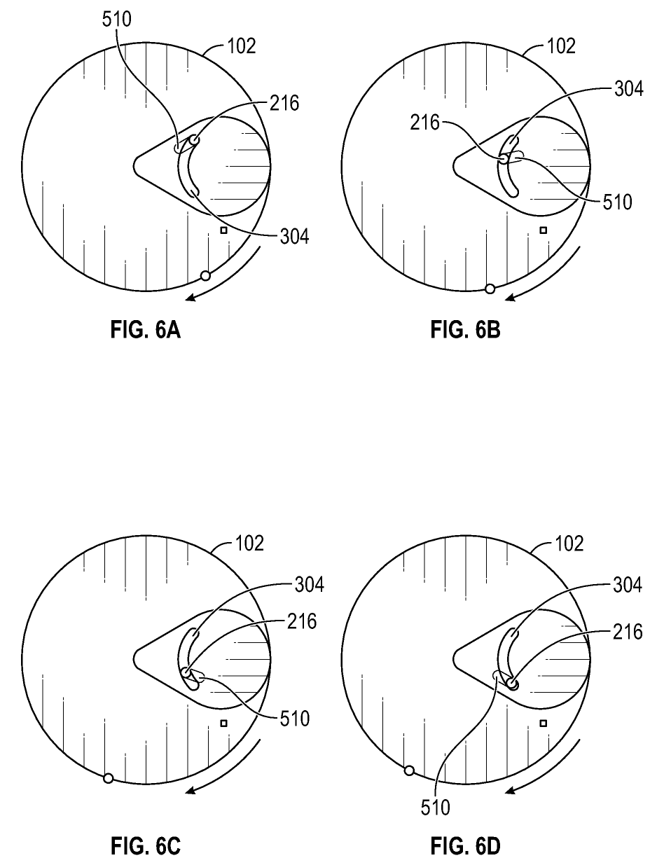

A rocking motion for a stroller is a feature in which the wheels of the stroller are moved backward and forward a predefined number of degrees/rotations, which may help soothe an infant placed in the stroller. As explained above, the wheels 102 and 104 may be driven by one or more motors. In an embodiment, the one or more motors may be activated to execute the rocking motion. In other embodiments, the user may physically push the stroller forward and backward once the rocking mode is enabled. FIGS. 6A-6D illustrate schematics that explain the operation of the rocking feature in accordance with the embodiments of the present disclosure. The FIGS. 6A-6D show a side view of the wheel 102 as it rotates in a first direction and corresponding motion of the respective elongated opening 510, the motion of the rocking pin 216 within the slot 304 of the rocking lifter 212. The direction of rotation of the wheel 102 is indicated by the arrow in FIGS. 6A-6D. It is to be understood that the movement of the elongated opening 510 and the rocking pin 216 will be similar when the wheel is rotated in a direction that is opposite to the direction shown in FIGS. 6A-6D. It is to be understood that FIGS. 6A-6D illustrate a single wheel 102, however, the motion of the elongated opening 510 and the rocking pin 216 is substantially similar or identical for the other wheel 104.

As explained above, once the rocking mode is enabled, the rocking pin 216 engages with one of the second plurality of elongated openings 510 and the slot 304 of the rocking lifter 212. As illustrated in FIG. 6A, at the beginning of the rocking motion the wheel 102 (and the wheel 104) is in the first position, the rocking pin 216 is located at a first end of the elongated opening 510 and at one end of the slot 304. As the wheel 102 is rotated in the direction shown (which would result in the stroller moving backward), the rocking pin concurrently travels within the elongated opening 510 and the slot 304. FIG. 6B illustrates a second position of the wheel 102. In this position, the rocking pin has travelled a first distance from its first position in the slot 304 to a second position within the slot 304. Further, in the second position of the wheel 102, the rocking pin 216 is now positioned at a second end of the elongated opening 510 that is opposite to the first end of the elongated opening 510. In other words, the rocking pin 216 has traversed the entire length of the elongated opening 510. It is to be understood that since the wheel 102 is rotating around the second axis 512, the associated motor cover 502 is also rotating around the second axis 512 and hence the elongated opening 510 is also rotating along with the wheel 102 and the motor cover 502. FIG. 6C shows the wheel 102 in a third position along its travel. In this position of the wheel 102, the rocking pin 216 is at a third position within the slot 304. The third position of the rocking pin 216 is now closer to the other end of the slot 304. Concurrently, the rocking pin 216 has now started to travel back to the first end of the elongated opening 510. FIG. 6D illustrates the wheel in a fourth position. In this position, the rocking pin 216 is now located at the second end of the slot 304 or close to the second end of the slot 304. Concurrently, the rocking pin 216 is now positioned at the first end of the elongated opening 510. Thus, during the time when the wheel 102 travels between the first position and the fourth position, the rocking pin 216 travels between the first end of the elongated opening 510 to the second end of the elongated opening 510 and back to the first end of the elongated opening 510. This completes a first cycle of the rocking motion in a first direction. The wheel 102 now may be rotated in a direction opposite to what is shown in FIGS. 6A-6D and the motion of the rocking pin 216 and the elongated opening 510 will be reversed until the rocking pin 216 reaches the other end of the slot 304. This completes a second cycle of the rocking motion. This forward and backward motion of the wheel 102 can be repeated to simulate the rocking effect. It is to be noted that during the rocking motion, the rocking lifter 212 and consequently the slot 304 are stationary and do not move since the pedal assembly is configured to rotate along a different axis than the wheel 102.

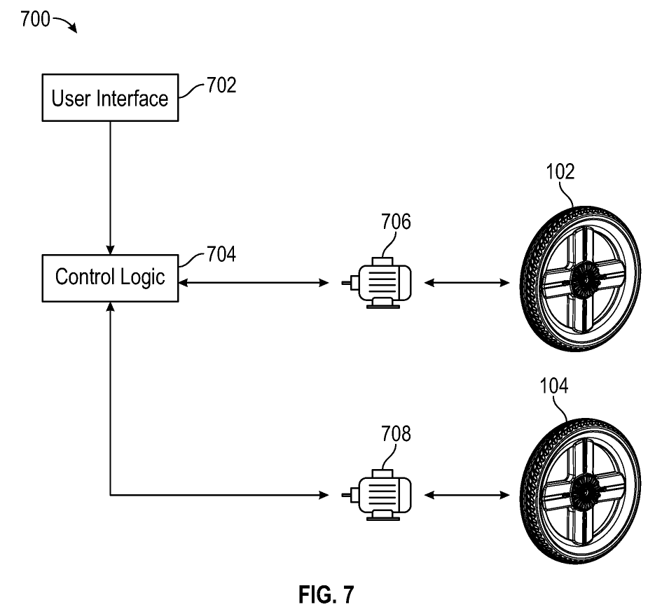

In order for executing the rocking motion, it is not necessary for the rocking pin 216 to travel from one end of the slot 304 to the other end of the slot 304. The two ends of the slot 304 act as emergency hard stops beyond which the motion of the rocking pin 216 is not possible, thus providing a backup for ensuring that the stroller does not move beyond a certain distance in both the forward and backward directions. The amount of rocking motion desired may be controlled using a user interface associated with the stroller. A user may select, via the user interface, the desired amount of rocking motion. FIG. 7 illustrates a block diagram of a system 700 of a power assisted stroller in accordance with the principles of the disclosure. The system 700 includes a user interface 702. The user interface 702 may include one or more control inputs that enable a user to select the desired amount of rocking motion. For example, the user interface 702 may include a multi-function button or a touch screen to enable a user to select the desired amount of rocking motion. In an embodiment, the user interface may be integrated into a handle of the stroller. The system 700 may also include control logic 704. The control logic 704 may include one or more processors and one or more memories that store instructions. The one or more processors may execute the instructions to control and execute the rocking motion based on the user selection. The control logic 704 may be electrically coupled to a first motor 706 and a second motor 708. The motors 706 and/or 708 may include brushless DC motors, direct-drive motors, in-wheel motors or the like. In an embodiment, the system 700 may include more than two motors. The first motor 706 may be coupled with the first wheel 102 and the second motor 708 may be coupled to the second wheel 104. The control logic 704 may receive the user input data from the user interface, determine the desired amount of rocking selected, and operate the first motor 706 and the second motor 708 to effect the rocking motion.

In an embodiment, the rocking motion is controlled based on the absolute position of the first motor 706 and the second motor 708. Each of the first motor 706 and the second motor 707 may include one or more sensors, such as a hall-effect sensors, that may be used to determine the absolute position of the first motor 706 and the second motor 708 at any given point. In an embodiment, a rotary encoder may be used in lieu of or in addition to the hall effect sensors. Once the absolute position of the first motor 706 and the second motor 708 is known, the control logic 704 can then operate the first motor 706 and the second motor 708 based on the desired amount of rocking. For example, the desired amount of rocking may be translated into degrees and the first motor 706 and the second motor 708 may be moved backward and forward by the determined number of degrees. In an embodiment, the first motor 706 and the second motor 708 may be moved backward and forward between 10 and 50 degrees.

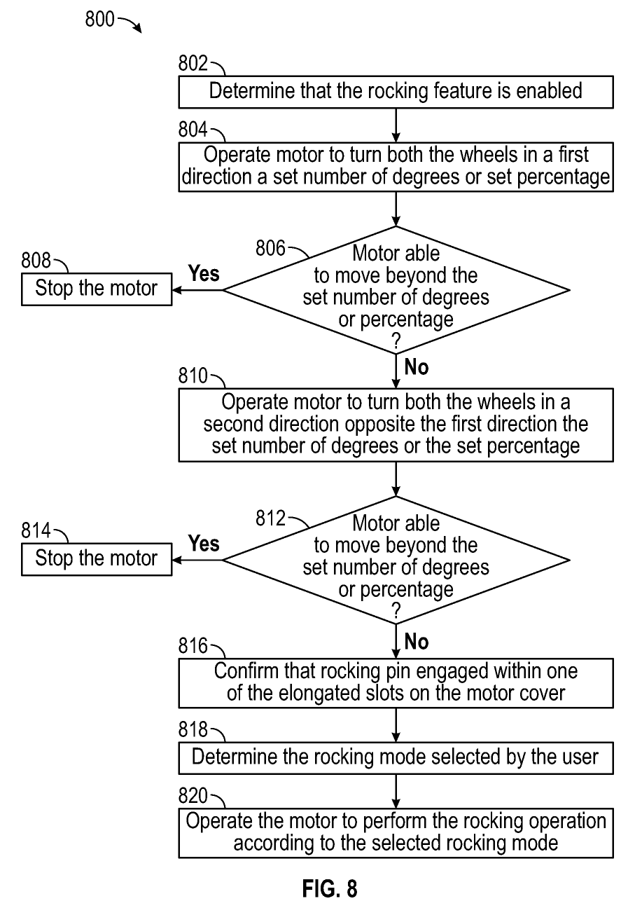

FIG. 8 is a flow diagram of a process 800 for executing the rocking feature in accordance with the principles of the present disclosure. The process 800 may be performed by the system 700 in an embodiment of the present disclosure. It is to be noted that the steps mentioned below are performed for both of the back wheels of the stroller. At step 802, it is determined that the rocking feature is enabled. In an embodiment, the determination of whether the rocking feature is enabled is made based on the operation of the pedal lever 204. As mentioned above, operation of the pedal lever 204 engages the rocking pin 216 with one of the elongated openings 510 in the motor cover 502 and with the slot 304 of the rocking lifter 212. In addition, the user may also select the amount of desired rocking motion via the user interface 702. This may be another indication that the rocking mode is enabled. As explained above, once the rocking pin 216 is engaged with the slot 304, the rocking pin 216 toward one end of the slot 304. Therefore, at this point the physical location of the rocking pin 216 within the slot 304 is known. Thereafter, at step 804, the absolute position of the motor is determined. Once the absolute position is determined, the motor is rotated by a predefined number of degrees in a first direction. In an embodiment, the first direction may be a forward direction. If the rocking pin 216 is correctly engaged with the slot 304 and the elongated opening 510 in the motor cover 502, rotating the motor by the pre-defined number of degrees will result in the rocking pin moving to the other end of the slot 304. Thereafter, the motor will be unable to rotate any further since the rocking pin 216 would have encountered the hard stop of the slot 304. At step 804, the motor is first moved in the first direction by the predefined number of degrees. Thereafter, the system may try/attempt to move the motor by a few more degrees to check whether the motor is able to move farther than the pre-defined number of degrees.

At step 806, it is determined whether the motor can move beyond the predefined number of degrees. If the motor is able to move beyond the set number of degrees, it may be an indication that the rocking pin 216 is not properly engaged with the slot 304. Thus, if it is determined at step 806, that the motor is able to move beyond the set number of degrees, the rocking mode is disabled and the motor is stopped at step 808. In an embodiment, an error message may be displayed on the user interface indicative of the rocking mode being disabled.

If at step 806, it is determined that the motor cannot be moved beyond the predefined number of degrees, the system may conclude that the rocking pin 216 has reached one end of the slot 304 and is in contact with the hard stop of the rocking lifter 212. This may indicate that the rocking pin 216 is correctly engaged with the rocking lifter 212. Once it is determined that the motor cannot be moved beyond the predefined number of degrees in the first direction, the motor may be moved in a second direction opposite the first direction by the predefined number of degrees, at step 810. If the rocking pin 216 is correctly engaged with the slot 304, the motor will not be able to be moved beyond the predefined number of degrees in the second direction. At step 812, it is determined whether the motor can be moved beyond the predefined number of degrees in the second direction.

If at step 812, it is determined that the motor can be moved beyond the predefined number of degrees in the second direction, the system may conclude that there is some issue with alignment between the rocking pin, the rocking lifter, and/or the elongated opening in the motor cover. Based on this determination, the system may cancel the rocking mode and stop the motor at step 814. In most instances, if the motor cannot be moved beyond the predefined number of degrees in the first direction at step 804, it is unlikely that the motor can be moved beyond the predefined number of degrees in the second direction at step 810. If at step 812, it is determined that the motor cannot be moved beyond the predefined number degrees in the second direction, the system may conclude, at step 816, that the rocking pin is properly engaged within the slot in the rocking lifter and the elongated opening in the motor cover.

Thereafter, at step 818, the system may determine the details of the rocking mode selected by the user. As noted above, it is not necessary that the rocking pin traverse the entire distance of the slot 304 in the rocking lifter 212 as part of the rocking motion. The user may select any amount of desired rocking that results in the rocking pin traversing any distance that is less than the full length of the slot 304 in the rocking lifter 212. For example, the user may select traversal of 80% of the full length of the slot 304 or any other suitable percentage of the full length of the slot 304. At step 820, the system may operate the motor to execute the rocking motion. In an embodiment, once the range of motion for the motor in the first direction and the second direction is known based on operations in step 804 and 810, the motor may move to a middle position of that range and start the rocking motion from that point based on the absolute position of the motor determined using the one or more sensors and the extent of the rocking motion selected by the user. For instance, from the middle position, the motor may move forward and backward a set number of degrees based on the amount of rocking motion desired/selected by the user. In most instances of the rocking motion, the rocking pin does not traverse the full length of the slot 304 in the rocking lifter 212. In some embodiments, the user may be able to select between a first rocking mode and a second rocking mode. In the first rocking mode, the motor may be configured to move a first number of degrees in a first direction and an opposing second direction, from a starting position. In the second rocking mode, the motor may be configured to move a second number of degrees in the first direction and the opposing second direction, from the starting position. In an embodiment, the second number of degrees is higher than the first number of degrees. In another mode, each of the first the rocking mode or the second rocking mode may have variable speed selections. In other embodiments, the two wheels may be rotated in opposite directions to effect a twisting/swaying motion.

In some embodiments, the user may be able to select a time duration for which the rocking motion is to be performed. For example, the user may select a specific time duration (e.g., in minutes or seconds) for which the rocking motion is to be performed. Once the selected time duration expires, the system may automatically stop the rocking motion and cause the stroller to remain still or idle. In other embodiments, the stroller may be equipped with sensors that detect movement within the stroller. In this embodiment, the sensors may continually monitor the motion of an infant placed in the stroller. If at any time during the execution of the rocking feature, the sensors determine that there is no motion detected, the system may conclude that the infant is either sleeping or no longer in the stroller. In this instance, the system may automatically cancel the rocking mode and cause the stroller to be still.

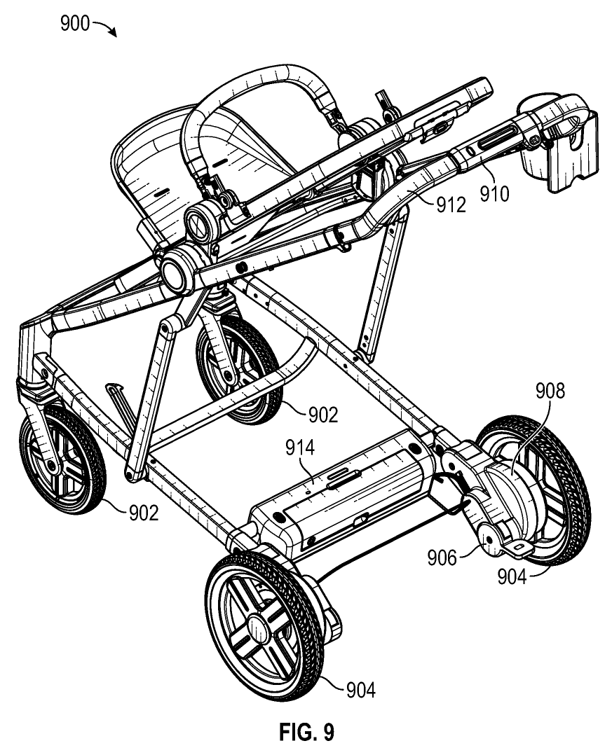

FIG. 9 illustrates a stroller 900 in accordance with the principles of the present disclosure. It is to be noted that the stroller 900 is exemplary and other stroller designs having more or less components than the stroller 900, having components placed in a different arrangement than the stroller 900, and/or having a different configuration than stroller 900 are all within the scope of this disclosure as long as the stroller performs a rocking motion as described in the embodiments above. Stroller 900 may include a pair of front wheels 902 and a pair of back wheels 904. The back wheels 904 may be similar to the wheels 102 and 104 described above. Each of the back wheels 904 may be coupled to a motor assembly 908. The motor assembly 908 may be similar to the motor assembly 110 described above. A pedal assembly 906 may be coupled to each of the back wheels 904. As noted above, the two pedal assemblies coupled to the two back wheels are almost identical in structure expect one of the pedal assemblies for one of the back wheels 904 does not include the lever 204 described above. The pedal assemblies 906 may be similar to the pedal assemblies 108 and 114 described above. The stroller 900 may also include a power source 914 configured to supply power to the motor assemblies 908 in order to operate motors. In an embodiment, the power source may include rechargeable lithium-ion batteries. The stroller 900 may further include a handle 912 that may be used to maneuver the stroller 900. In an embodiment, a user interface 910 may be integrated into the handle 912. The user interface 910 may be similar to the user interface 702 described above.

The present disclosure provides details on a specific type of power assisted stroller with a rocking feature, but one skilled in the art will realize that other types of power assisted strollers with rocking feature may also be manufactured using the systems and methods provided in this disclosure.

One or more illustrative embodiments of the disclosure have been described above. The above-described embodiments are merely illustrative of the scope of this disclosure and are not intended to be limiting in any way. Accordingly, variations, modifications, and equivalents of the embodiments disclosed herein are also within the scope of this disclosure.

While the present disclosure has been described with reference to a number of embodiments, it will be understood by those skilled in the art that the invention is not limited to such disclosed embodiments. Rather, the disclosure can be modified to incorporate any number of variations, alterations, substitutions, or equivalent arrangements not described herein, but which are commensurate with the spirit and scope of the disclosure. Additionally, while various embodiments of the disclosure have been described, it is to be understood that aspects of the disclosure may include only some of the described embodiments. Accordingly, the disclosure is not to be seen as limited by the foregoing description but is only limited by the scope of the appended claims.

What is claimed is:

1. A stroller comprising:
a first wheel and a second wheel;
a first motor assembly coupled to the first wheel;
a second motor assembly coupled to the second wheel;
a first pedal assembly coupled to the first motor assembly, the first pedal assembly comprising:
a first pin and a second pin;
a rocking lifter defining a slot therein;
a pin housing at least partially encompassing the second pin;
a first pin configured to engage with a first opening of the first motor assembly;
a second pin configured to engage with a second opening of the first motor assembly and the slot; and
a first spring coupled to the pin housing and the rocking lifter.

2. The stroller of claim 1, further comprising:
a second pedal assembly coupled to the second motor assembly and wherein the first pedal assembly includes a lever configured to be rotated around a first axis.

3. The stroller of claim 2, wherein the first wheel is configured to be rotated around a second axis that is different than the first axis.

4. The stroller of claim 1, wherein the first opening is part of a first plurality of openings and the second opening is part of a second plurality of openings and wherein the first plurality of openings are arranged in a radial pattern along a periphery of a motor cover of the motor assembly and the second plurality of openings are arranged in a radial pattern around a center of the motor cover.

5. The stroller of claim 1, further comprising a control unit, the control unit being operable to:
select a rocking mode, from among multiple rocking modes;
determine one or more parameters for operating the first motor assembly and the second motor assembly based on the rocking mode; and
operate the first motor assembly and the second motor assembly based on the one or more parameters.

6. The stroller of claim 1, wherein the first pedal assembly includes a pedal cover, the pedal cover comprising:
a first raised structure including a plurality of recessed areas; and
a second raised structure having a planar top.

7. The stroller of claim 6, wherein the first raised structure has a first height at a first end of the first raised structure and a second height at a second opposing end of the first raised structure and wherein the first height is greater than the second height.

8. The stroller of claim 1, wherein the stroller is configured to be operated in a first mode and a second mode,
wherein in the first mode, the first pin is engaged with the first opening and the second pin is disengaged from the second opening; and
wherein in the second mode, the first pin is disengaged from the first opening and the second pin is engaged with the second opening and the slot.

9. A stroller comprising:
a wheel;
a motor assembly comprising a motor coupled to the wheel; and
a pedal assembly coupled to the motor and the wheel, the pedal assembly being rotatable around a first axis and the motor being rotatable around a second axis that is different from the first axis;
the pedal assembly comprising:
a pedal lever;
a first pin partially disposed in a first housing;
a second pin partially disposed in a second housing;
a spring coupled to the second housing and located adjacent to the second housing; and
a rocking lifter coupled to the second housing, wherein the spring is configured to bias the second housing such that the second pin engages with a slot in the rocking lifter at the same position.

10. The stroller of claim 9, wherein the motor assembly further comprises a motor cover, the motor cover comprising:
a first plurality of openings that are arranged around a periphery of the motor cover; and
a second plurality of openings that are arranged around a center of the motor cover, wherein the second plurality of openings are arranged in a radial manner and each opening of the second plurality of openings defines an elongated slot having a first length.

11. The stroller of claim 10, wherein in a first mode of operation of the stroller:
the second pin is engaged with one of the second plurality of openings; and
the second pin is engaged with a slot in the rocking lifter.

12. The stroller of claim 9, further comprising a user interface, wherein the user interface includes one or more control inputs operable to select a rocking mode of operation for the stroller.

13. The stroller of claim 12, wherein the one or more control inputs include a multi-function button operable to select a rocking mode from among multiple rocking modes.

14. The stroller of claim 12, further comprising control logic electrically coupled to the user interface and the motor and wherein the control logic is configured to:
receive an input from the user interface indicative of selection of the rocking mode;
determine, based on the rocking mode, one or more parameters for operating the motor; and
operating the motor based on the one or more parameters to effect the rocking mode.

15. The stroller of claim 9, wherein the motor assembly further comprises a motor cover, the motor cover comprising:
a first plurality of openings arranged around a periphery of the motor cover;
a second plurality of openings arranged around a center of the motor cover; and
the pedal assembly is operable to be placed in a first position and a second position, wherein:
in the first position, the first pin is engaged with one opening of the first plurality of openings preventing the stroller from being moved; and
in the second position, the second pin is engaged with one opening of the second plurality of openings and with the slot in the rocking lifter, allowing the wheel to rotate by a predefined number of degrees in a first direction and a second direction opposite to the first direction.

16. A method comprising:
operating, by a control logic of stroller, a motor of the stroller in a first direction by a predefined number of degrees;
determining, by the control logic, that the motor cannot be rotated in the first direction beyond the predefined number of degrees;
operating, by the control logic, the motor in a second direction by the predefined number of degrees, the second direction being opposite the first direction; and
operating, by the control logic, the motor the first direction and the second direction by a first number of degrees that is less than the predefined number of degrees.

17. The method of claim 16, further comprising receiving, by the control logic from a user interface of the stroller, data indicative of selection of a rocking mode.

18. The method of claim 16, further comprising placing a pedal assembly of the stroller in a first position.

19. The method of claim 16, further comprising determining, by the control logic, an absolute position of the motor prior to operating the motor in the first direction by the predefined number of degrees.

20. The method of claim 16, further comprising, prior to operating the motor in the first direction and the second direction by a first number of degrees, placing the motor in a middle of a range defined by the predefined number of degrees in the first direction and the second direction.
